(19) United States
(12) Patent Application Publication
(10) Pub. No.: US 2026/0057634 A1
(43) Pub. Date: Feb. 26, 2026

(54) COMPUTER AND INFORMATION PROCESSING METHOD

(71) Applicant: Knowhere, Inc., Tokyo (JP)

(72) Inventors: Tatsuya IMAI, Tokyo (JP); Hisashi ITO, Tokyo (JP)

(73) Assignee: Knowhere, Inc., Tokyo (JP)

(21) Appl. No.: 19/181,355

(22) Filed: Apr. 17, 2025

(30) Foreign Application Priority Data
Aug. 22, 2024 (JP) 2024-141060

(51) Int. Cl. G06V 10/25; G06T 5/50; G06T 5/70; G06T 7/20; G06T 7/70; G06T 17/00

(52) U.S. Cl. CPC G06V 10/25; G06T 5/50; G06T 5/70; G06T 7/20; G06T 7/70; G06T 17/00; G06T 2207/20221; G06V 2201/07

(57) ABSTRACT

Provided are a computer and an information processing method for accurately detecting a moving object in a captured image of the moving object. This computer includes: a memory that stores a computer program; and processing circuitry configured to, through execution of the computer program, generate a two-dimensional training image on which a moving object model and a background model placed in a three-dimensional virtual space are projected and which includes an afterimage according to movement of the moving object model, specify an in-image position, in the training image, of a moving object area including an image of at least one said moving object model, and use a combination of the training image and the in-image position of the moving object area as training data, to generate a detection model for detecting a moving object area from a captured image including an afterimage according to movement of a moving object.

### CROSS-REFERENCE TO RELATED APPLICATION

This application claims the benefit of Japanese Patent Application No. 2024-141060 filed on Aug. 22, 2024, the entire disclosures of which are incorporated herein by reference.

### TECHNICAL FIELD

The present invention relates to a computer and an information processing method.

### BACKGROUND ART

Conventionally, there have been known technologies for generating a detection model for detecting a predetermined object from a captured image, through machine learning. Japanese Laid-Open Patent Publication No. 2020-046858 discloses a technology for generating an image of a cut area including a target, using an automatic cutting device generated through learning based on manually cut images obtained by manually cutting areas including targets from material images.

### SUMMARY OF THE INVENTION

For example, in a captured image of a flying ball, a so-called afterimage in which an image of the ball appears in a line shape can been seen in a case where the flying speed is fast. There has been a problem that it is difficult to accurately specify a moving object in a captured image including such an afterimage.

Considering the above circumstances, an object of the present invention is to provide a computer and an information processing method for accurately detecting a moving object in a captured image of the moving object.

A computer of the present invention includes:
a memory that stores a computer program; and
processing circuitry, where the computer program, when executed by the processing circuitry, causes the processing circuitry to
generate a two-dimensional training image on which a moving object model and a background model placed in a three-dimensional virtual space are projected and which includes an afterimage according to movement of the moving object model,
specify an in-image position, in the training image, of a moving object area including an image of at least one said moving object model, and
generate a detection model for detecting a moving object area from a captured image including an afterimage according to movement of a moving object by using a combination of the training image and the in-image position of the moving object area as training data.

In the computer of the present invention, the computer program may further cause the processing circuitry to
generate a plurality of two-dimensional images in which the moving object model is placed at different positions in accordance with movement of the moving object model, and
generate the training image, based on the plurality of two-dimensional images.

In the computer of the present invention, the computer program may further cause the processing circuitry to specify, as the in-image position of the moving object area, a position of an area including the plurality of moving object models, in the training image.

In the computer of the present invention, the computer program may further cause the processing circuitry to generate a two-dimensional image including the moving object model and the background model placed in the three-dimensional virtual space, and perform blurring processing on an image of the moving object model included in the two-dimensional image, to generate the training image.

In the computer of the present invention, the computer program may further cause the processing circuitry to specify the in-image position of the moving object area including an area that has undergone the blurring processing.

In the computer of the present invention, the computer program may further cause the processing circuitry to specify, as the in-image position, a position in the training image that corresponds to a position of the moving object area in the two-dimensional image that has not undergone the blurring processing yet.

In the computer of the present invention, the computer program may further cause the processing circuitry to generate a plurality of two-dimensional images in which the moving object model is placed at different positions in accordance with movement of the moving object model, generate a synthesized image based on the plurality of two-dimensional images, and generate the training image by performing blurring processing on an image of the moving object model included in the synthesized image.

In the computer of the present invention, the moving object area may be a rectangular area enclosing the image of the at least one moving object model.

A computer of the present invention includes:
a memory that stores a computer program; and
processing circuitry, where the computer program, when executed by the processing circuitry, causes the processing circuitry to
acquire a captured image including an afterimage according to movement of a moving object, and
detecting a moving object area including a moving object from the acquired captured image by using a detection model for detecting the moving object area from a captured image including an afterimage according to movement of a moving object, wherein
the detection model is generated by
   generating a two-dimensional training image on which a moving object model and a background model placed in a three-dimensional virtual space are projected and which includes an afterimage according to movement of the moving object model,
   specifying an in-image position, in the training image, of a moving object area including an image of at least one said moving object model, and
   using a combination of the training image and the in-image position of the moving object area as training data.

An information processing method of the present invention is an information processing method to be performed by a computer including a control section, the method including the steps of:
the control section acquiring a captured image including an afterimage according to movement of a moving object, and
using a detection model for detecting a moving object area including a moving object from a captured image including an afterimage according to movement of a moving object, the control section detecting the moving object area from the acquired captured image, wherein
the detection model is generated by
   generating a two-dimensional training image on which a moving object model and a background model placed in a three-dimensional virtual space are projected and which includes an afterimage according to movement of the moving object model,
   specifying an in-image position, in the training image, of a moving object area including an image of at least one said moving object model, and
   using a combination of the training image and the in-image position of the moving object area as training data.

The computer and the information processing method of the present invention can provide a technology for accurately detecting a moving object in a captured image including the moving object.

### BRIEF DESCRIPTION OF THE DRAWINGS

FIG. 1 is an entire configuration diagram of an information processing system.

FIG. 2 illustrates flow of data in a learning unit and a detection unit.

FIG. 3 illustrates training images.

FIG. 4 illustrates a moving object area.

FIG. 5 is a flowchart showing a learning process.

FIG. 6 is a flowchart showing a detection process.

FIG. 7 illustrates a moving object area according to a modification.

### DETAILED DESCRIPTION

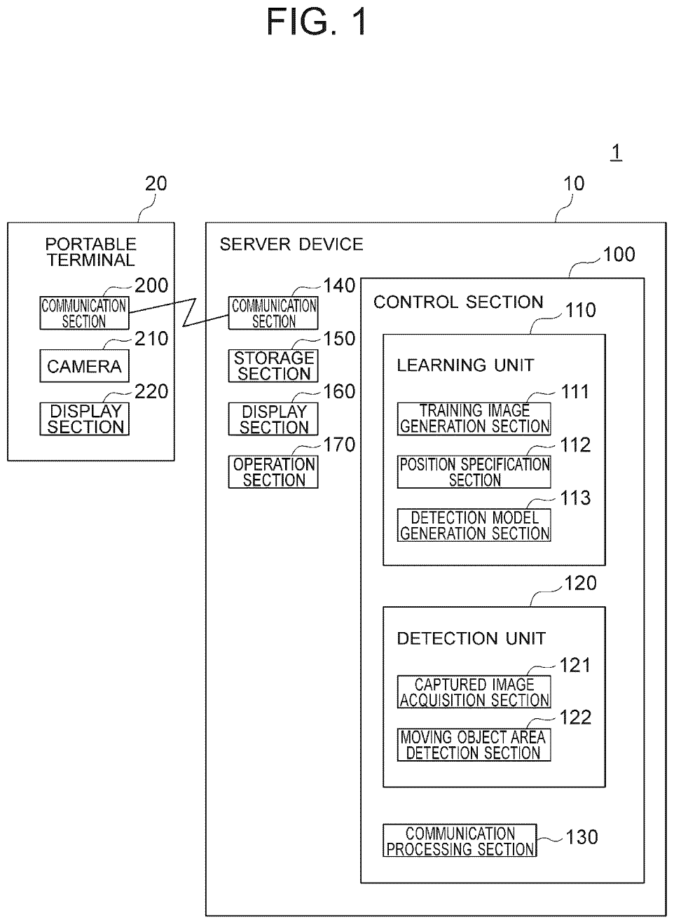

Hereinafter, with reference to the drawings, an embodiment of the present invention will be described. FIG. 1 to FIG. 7 show a program, an information processing system, an information processing method, and the like according to the present embodiment.

FIG. 1 is an entire configuration diagram of an information processing system 1 according to the present embodiment. The information processing system 1 detects a moving object area which is an area of an image of a moving object from a captured image including an afterimage according to movement of the moving object, captured by a camera 210.

Examples of a moving object to be detected include a baseball thrown by a pitcher, a tennis ball shot by a tennis racket, a golf ball shot by a golf club, and a ball released from an apparatus such as a pitching machine. Such a moving object to be detected may be any moving object that moves so fast relative to a shutter speed that the object appears in a line shape along the movement line thereof and thus is captured as a so-called afterimage, in a captured image, and is not limited to a ball.

The information processing system 1 includes a server device 10 and a portable terminal 20. The server device 10 and the portable terminal 20 are connected communicably with each other via a communication network 2 such as the Internet. Here, the server device 10 is composed of a computer and the like, and includes a control section 100, a communication section 140, a storage section 150, a display section 160, and an operation section 170.

The control section 100 includes processing circuitry such as a central processing unit (CPU) and a graphics processing unit (GPU), and controls operation of the server device 10. The communication section 140 includes a communication interface for performing communication with an external device wirelessly or via a wire. The control section 100 transmits/receives data to/from the portable terminal 20 via the communication section 140.

The storage section 150 includes, for example, a hard disk drive (HDD), a random access memory (RAM), a read only memory (ROM), a solid state drive (SSD), and the like. The storage section 150 is not limited to that included in the server device 10, and may be a storage medium (e.g. a USB memory) that is attachable/detachable to/from the server device 10. In the present embodiment, the storage section 150 stores a program to be executed by the control section 100, and a detection model. The detection model will be described later.

The display section 160 is, for example, a monitor or the like, and displays various screens by receiving display commands from the control section 100. The operation section 170 is, for example, a keyboard or the like, and can provide various commands to the control section 100.

The portable terminal 20 includes a communication section 200, the camera 210, and a display section 220. The communication section 200 includes a communication interface for performing communication with an external device wirelessly or via a wire. The camera 210 captures an image. The image captured by the camera 210 is transmitted to the server device 10 via the communication section 200. The display section 220 is, for example, a monitor or the like, and displays various screens. The display section 220 displays, for example, the captured image.

As the portable terminal 20, for example, a smartphone, a PC tablet, or the like may be used. As the portable terminal 20, a camera or the like capable of communicating with an external device may be used.

In the present embodiment, a capturing application can be installed on the portable terminal 20. When the capturing application installed on the portable terminal 20 is started, the capturing application allows the camera 210 to capture an image.

By the capturing application of the portable terminal 20, information on the capturing date and time of the captured image is acquired. Then, when the captured image is obtained, the captured image and the capturing date and time are transmitted in a state of being associated with each other from the portable terminal 20 to the server device 10.

Next, the configuration of the control section 100 of the server device 10 will be described. The control section 100 executes the program stored in the storage section 150 described later, to function as a learning unit 110, a detection unit 120, and a communication processing section 130.

The learning unit 110 is a function section that trains a detection model to be used for detecting a moving object from a captured image. The detection model of the present embodiment is for detecting a moving object from a captured image including an afterimage of the moving object. Specifically, the detection model is for detecting a moving object area in a captured image including an afterimage according to movement of a moving object. The moving object area is a so-called bounding box which is a minimum rectangular area including an image of a moving object to be detected. In another example, the moving object area may be an area having, as a boundary position, a boundary line of a moving object to be detected.

The detection unit 120 is a function section that acquires the image captured by the camera 210 in the portable terminal 20 and detects a moving object area in the captured image. In detection for the moving object area, the detection model generated by the learning unit 110 is used.

The learning unit 110 includes a training image generation section 111, a position specification section 112, and a detection model generation section 113. The detection unit 120 includes a captured image acquisition section 121 and a moving object area detection section 122. In the following description, processes described as being performed by the training image generation section 111, the position specification section 112, the detection model generation section 113, the captured image acquisition section 121, the moving object area detection section 122, and the communication processing section 130 are processes to be performed by the control section 100 executing the program.

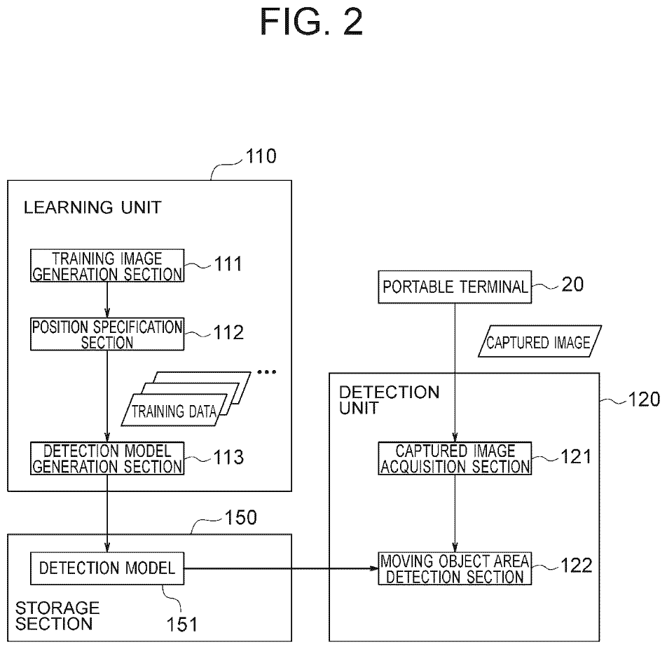

FIG. 2 illustrates flow of data in the learning unit 110 and the detection unit 120. The learning unit 110 generates training data to be used for training the detection model. Here, the training data is data of combinations of training images and in-image positions. Here, each training image included in the training data is a two-dimensional image including an afterimage of a moving object and generated for training. Each in-image position included in the training data is information indicating the position, in a training image, of a moving object area detected from the training image. The in-image position of the moving object area is information indicating where the moving object area is located in the image, and specifically, information indicating the boundary of the moving object area. The information indicating the boundary of the moving object area may be, for example, coordinate information indicating the boundary of the moving object area, or information on a so-called mask image for designating whether or not each pixel is included in the moving object area.

The training image generation section 111 generates a training image. Hereinafter, a process for generating a training image will be described. First, the training image generation section 111 places a background and a moving object model represented by three-dimensional computer graphics (3DCG), in a virtual three-dimensional space. Here, the moving object model is formed by at least one polygon. The training image generation section 111 places a virtual camera in the virtual space in which a plurality of moving object models and the background are placed, and virtually captures the inside of the virtual space by the virtual camera, to generate a two-dimensional image.

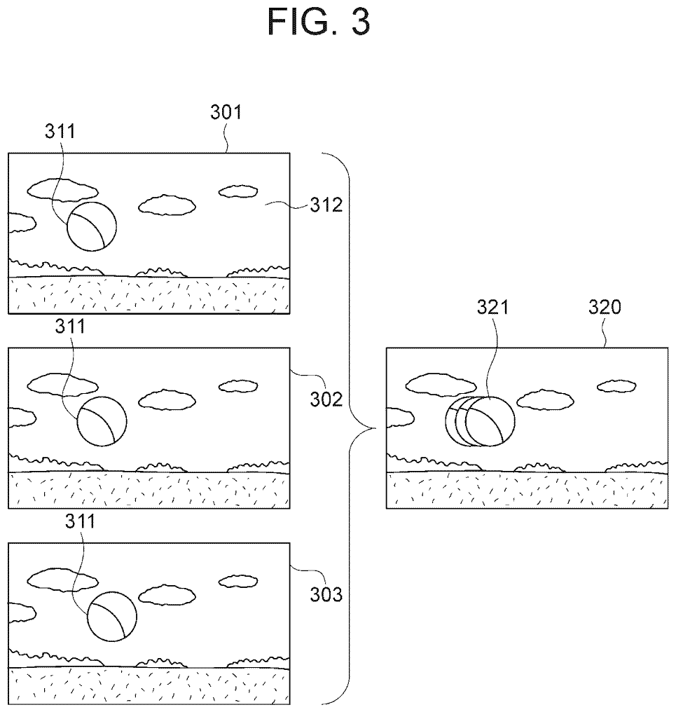

Thus, for example, a two-dimensional image 301 shown in FIG. 3 is generated. The two-dimensional image 301 includes a moving object model 311 and a background 312 which are projected two-dimensionally. The two-dimensional image 301 shown in FIG. 3 is an image including an afterimage according to flight of a baseball thrown by a pitcher. That is, the moving object model 311 is a 3D model representing the baseball.

Further, the training image generation section 111 generates a plurality of two-dimensional images along movement of the moving object. Thus, for example, as shown in FIG. 3, three two-dimensional images 301 to 303 along movement of the moving object are generated. Here, it is assumed that the baseball as the moving object moves from the left to the right of the two-dimensional image, and in accordance with this, the moving object model 311 moves from the left to the right sequentially in the two-dimensional images 301 to 303. That is, the position of the moving object model 311 differs among the two-dimensional images 301 to 303.

Then, the training image generation section 111 averages pixel values of the plurality of generated two-dimensional images, to obtain one training image. Thus, as shown on the right side in FIG. 3, a training image 320 including an afterimage image 321 in which a plurality of moving objects are arranged in series so as to represent an afterimage of the moving object, is generated. As described above, the training image generation section 111 generates a plurality of two-dimensional images and then averages pixel values of the plurality of two-dimensional images, to generate a training image including an afterimage.

The plurality of two-dimensional images generated by the training image generation section 111 are a plurality of two-dimensional images according to movement of the moving object at regular time intervals. However, time intervals between the plurality of two-dimensional images may not be constant. For example, a time interval between two-dimensional images earlier in time may be set to be wider than a time interval between two-dimensional images later in time. Thus, a training image closer to a frame obtained at a later timing is generated.

FIG. 3 shows an example in which a training image is generated from three two-dimensional images, for convenience of description. In order to make a training image closer to an actual captured image including an afterimage, it is preferable that more two-dimensional images are generated and pixel values thereof are averaged to generate a training image. In generation of a training image, the moving object model and the background may be imparted with information for reproducing material qualities and the like on their respective surfaces, and the intensity of light radiated to the moving object model, the position of a light source, and the like may be set.

The position specification section 112 shown in FIG. 2 specifies the in-image position of a moving object area in the training image generated by the training image generation section 111. Thus, the position specification section 112 performs annotation of the in-image position of the moving object area. The position specification section 112 of the present embodiment specifies, as the in-image position in the training image, the position of a rectangular area enclosing the moving object model in the two-dimensional image corresponding to the latest time in time series among the plurality of two-dimensional images used for generating the training image. A position in a two-dimensional image and a position in a training image are represented in the same coordinate system. The position of a moving object model in a captured image is obtained by converting the placement position of the moving object model in a virtual space through projection. At this time, the position of the virtual camera and the like are referred to.

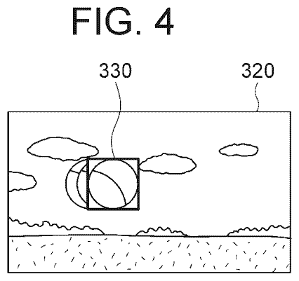

As shown in FIG. 3, in a case where it is assumed that a baseball is flying from the left to the right in a two-dimensional image, an area enclosing a moving object model 311 located at the rightmost position is specified as a moving object area 330, as shown in FIG. 4. Thus, annotation can be automatically performed. In another example, annotation may be performed in accordance with a user's operation.

The detection model generation section 113 shown in FIG. 2 acquires, as training data, a combination of the training image obtained by the training image generation section 111 and the in-image position of the moving object area obtained from the training image. The training image generation section 111 generates a plurality of different training images, and the position specification section 112 acquires a plurality of training data respectively corresponding to the plurality of different training images. Then, the position specification section 112 generates a detection model 151 through machine learning using the plurality of training data. As machine learning, various known methods such as deep learning may be used. The detection model 151 is stored in the storage section 150.

In the detection unit 120, the captured image acquisition section 121 acquires an image captured by the camera 210 in the portable terminal 20, via the communication section 140. The captured image includes an afterimage of a moving object.

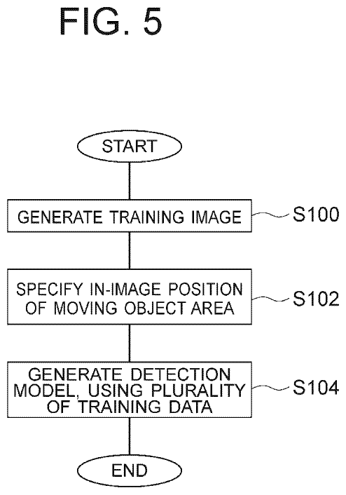

The moving object area detection section 122 detects a moving object area from a captured image, using the detection model 151 generated by the learning unit 110 and stored in the storage section 150. Thus, even in a case where an afterimage is included in the captured image, an area where the moving object is present at the latest timing in the afterimage can be detected as a moving object area. Specifically, the moving object area detection section 122 specifies information indicating the boundary of the moving object area. Next, a process by the learning unit 110 will be described. FIG. 5 is a flowchart showing a learning process by the learning unit 110. In the learning process, first, the training image generation section 111 of the learning unit 110 generates, as training data, a training image including an afterimage of a moving object by 3DCG (step S100). Next, the position specification section 112 specifies the in-image position of a moving object area in the training image (step S102). Through the above processing, training data which is a combination of the training image and the in-image position of the moving object area in the training image, is generated. Next, the detection model generation section 113 generates a detection model for detecting a moving object from a captured image including an afterimage, based on a plurality of training data (step S104). The detection model is stored in the storage section 150.

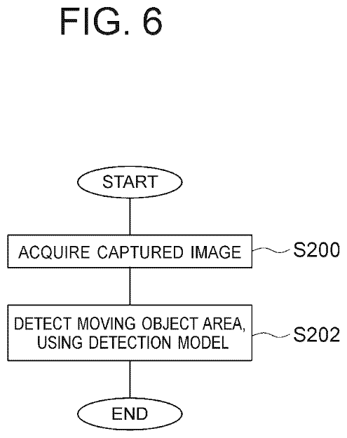

Next, a process by the detection unit 120 will be described. FIG. 6 is a flowchart showing a detection process by the detection unit 120. In the detection process, the captured image acquisition section 121 of the detection unit 120 acquires an image captured by the camera 210 and including an afterimage (step S200). Next, the moving object area detection section 122 detects a moving object area from the captured image, using the detection model stored in the storage section 150 (step S202).

As described above, the information processing system 1 of the present embodiment can accurately detect a moving object area even in a captured image including an afterimage. Further, the information processing system 1 of the present embodiment can generate a detection model for accurately detecting a moving object area from a captured image including an afterimage. Further, in generation of the detection model, training images can be generated using 3DCG, and therefore training data can be efficiently collected.

The program, the computer, the information processing system, the information processing method, and the like of the present invention are not limited to the configurations described above and the above embodiment may be modified variously.

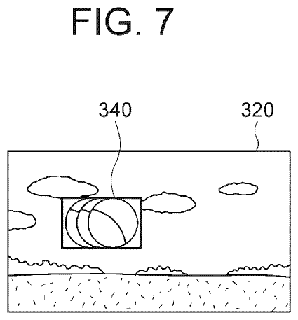

In a first modification, in the learning process for the detection model, as shown in FIG. 7, the position specification section 112 may set, as a moving object area, an area 340 including the entire afterimage of a moving object in a training image, and specify the in-image position of the moving object area. Here, the area 340 including the entire afterimage of the moving object is an area including a plurality of moving object models respectively included in a plurality of two-dimensional images used for generating the training image. For example, in the case of the three two-dimensional images 301 to 303 in FIG. 3, an area including all of the area of the moving object model 311 in the two-dimensional image 301, the area of the moving object model 311 in the two-dimensional image 302, and the area of the moving object model 311 in the two-dimensional image 303, is specified as a moving object area.

The position specification section 112 may specify, as a moving object area, an area including at least one moving object model in the area 340 including the entire afterimage of the moving object. As still another example, the position specification section 112 may specify, as a moving object area, an area corresponding to a moving object captured at the earliest timing in an area including an afterimage of the moving object. In this case, the position specification section 112 may specify, as an in-image position in a training image, a position of a moving object area in a two-dimensional image corresponding to the earliest time in time series among a plurality of two-dimensional images used for generating the training image.

In a second modification, the training image generation section 111 may generate a two-dimensional image including no afterimage, and then perform blurring processing on a moving object model in the two-dimensional image, to generate a training image including an afterimage. Here, the blurring processing is processing for making the boundary of an image of the moving object model obscure. In the blurring processing, each of pixels on the boundary of the moving object model is targeted. Then, with the processing target pixel as a center, the training image generation section 111 calculates the average of pixel values of the above pixel and pixels (e.g., nine pixels) therearound. Then, the training image generation section 111 changes the pixel value of the processing target pixel to the average value. By performing such processing on each pixel, an image that has undergone blurring, i.e., a training image, is obtained. As described above, it suffices that a training image including an afterimage is generated using 3DCG, and specific processing therefor is not limited to the present embodiment.

In a case where a training image is generated through blurring processing, the position specification section 112 specifies, as a moving object area, an area that has undergone blurring processing, i.e., an area including pixels of which pixel values have been changed through blurring processing, in the training image.

In another example, the position specification section 112 may specify, as an in-image position, the position of a rectangular area including an image of a moving object model in a two-dimensional image that has not undergone blurring processing yet.

In still another example, the training image generation section 111 may generate a plurality of two-dimensional images along movement of a moving object and synthesize these images, to generate a synthesized image. Then, the training image generation section 111 may perform blurring processing on the synthesized image, to generate a training image. Here, as the synthesized image, an image obtained by averaging pixel values of the plurality of two-dimensional images is used.

The training image generation section 111 may place a plurality of moving object models in one two-dimensional image, to obtain training data. In another example, the training image generation section 111 may place moving object models at a plurality of positions.

In a third modification, the server device 10 may acquire moving images representing movement of a moving object. In this case, the moving object area detection section 122 detects a moving object area including the moving object during movement, in each of frames included in the moving images.

In a fourth modification, the server device 10 may acquire moving images representing the flight state of a baseball, and estimate the flight state of the baseball, based on the moving images. In this case, the server device 10 may estimate the flight state, based on the capturing timing and the in-image position of the moving object area which is an area of the baseball in each frame, i.e., based on trajectory information indicating the flight trajectory of the baseball. Here, the flight state includes the initial velocity, the spin rate, the spin axis, and the like of the baseball.

For estimation of the flight state, an estimation model may be used. Here, training of the estimation model will be described. The server device 10 generates a plurality of flight states which are different in at least one condition of the initial velocity, the spin rate, and the spin axis of a baseball that a pitcher can throw. Then, the server device 10 generates trajectory information indicating position change with respect to temporal change of the baseball during flight, through physics simulation using a physics simulator, with the flight state inputted. In the physics simulator, as initial values of a thrown baseball, the velocity, the spin rate, and the tilt of the spin axis of the ball are inputted and thereby a trajectory of the ball flying under this condition is predicted. Further, the server device 10 sets, as one training data, the flight state given as an input and the trajectory information obtained as an output with respect to the flight state, and generates an estimation model for estimating a flight state from trajectory information, through machine learning using the training data.

In a fifth modification, the server device 10 may be realized as an information processing system composed of a plurality of devices. For example, in the information processing system, the learning unit 110 and the detection unit 120 may be configured as different devices.

In the computer and the information processing method of the present embodiment configured as described above, the training image generation section 111 generates a two-dimensional training image on which a moving object model and a background model placed in a three-dimensional virtual space are projected and which includes an afterimage according to movement of the moving object model, the position specification section 112 specifies an in-image position, in the training image, of a moving object area including an image of at least one moving object model, and the detection model generation section 113 generates a detection model for detecting a moving object area from a captured image including an afterimage according to movement of a moving object, by using a combination of the training image and the in-image position of the moving object area as training data.

By using the detection model generated as described above, it is possible to accurately detect a moving object even in a case where an afterimage is included in a captured image of the moving object.

In the computer and the information processing method of the present embodiment, the training image generation section 111 may generate a plurality of two-dimensional images in which the moving object model is placed at different positions in accordance with movement of the moving object model, and may generate the training image, based on the plurality of two-dimensional images. Thus, it is possible to efficiently generate the training data.

In the computer and the information processing method of the present embodiment, the position specification section 112 may specify, as the in-image position of the moving object area, a position of an area including the plurality of moving object models, in the training image. Thus, it is possible to automatically specify the in-image position of the moving object area.

In the computer and the information processing method of the present embodiment, the training image generation section 111 may generate a two-dimensional image including a moving object model and a background model placed in a three-dimensional virtual space, and may perform blurring processing on an image of the moving object model included in the two-dimensional image, to generate the training image. Thus, it is possible to efficiently generate the training image.

In the computer and the information processing method of the present embodiment, the position specification section 112 may specify the in-image position of the moving object area including an area that has undergone the blurring processing. Thus, it is possible to automatically specify the in-image position of the moving object area.

In the computer and the information processing method of the present embodiment, the position specification section 112 may specify, as the in-image position, a position in the training image that corresponds to a position of the moving object area in the two-dimensional image that has not undergone the blurring processing yet. Thus, it is possible to automatically specify the in-image position of the moving object area.

In the computer and the information processing method of the present embodiment, the training image generation section 111 may generate a plurality of two-dimensional images in which the moving object model is placed at different positions in accordance with movement of the moving object model, may generate a synthesized image based on the plurality of two-dimensional images, and may perform blurring processing on an image of the moving object model included in the synthesized image, to generate the training image. Thus, it is possible to efficiently generate the training image.

In the computer and the information processing method of the present embodiment, the moving object area may be a rectangular area enclosing the image of the at least one moving object model. Thus, it becomes possible to detect a moving object area in accordance with a usage purpose.

In the computer and the information processing method of the present embodiment, the captured image acquisition section 121 acquires a captured image including an afterimage according to movement of a moving object, and using a detection model for detecting a moving object area including a moving object from a captured image including an afterimage according to movement of a moving object, the moving object area detection section 122 detects the moving object area from the captured image acquired by the captured image acquisition section 121. Here, the detection model is generated by generating a two-dimensional training image on which a moving object model and a background model placed in a three-dimensional virtual space are projected and which includes an afterimage according to movement of the moving object model, specifying an in-image position, in the training image, of a moving object area including an image of at least one said moving object model, and using a combination of the training image and the in-image position of the moving object area as training data. Thus, it is possible to accurately detect a moving object even in a case where an afterimage is included in a captured image of the moving object.

1. A computer comprising:
a memory that stores a computer program; and
processing circuitry, where the computer program, when executed by the processing circuitry, causes the processing circuitry to
generate a two-dimensional training image on which a moving object model and a background model placed in a three-dimensional virtual space are projected and which includes an afterimage according to movement of the moving object model,
specify an in-image position, in the training image, of a moving object area including an image of at least one said moving object model, and
generate a detection model for detecting a moving object area from a captured image including an afterimage according to movement of a moving object by using a combination of the training image and the in-image position of the moving object area as training data.

2. The computer according to claim 1, wherein the computer program further causes the processing circuitry to
generate a plurality of two-dimensional images in which the moving object model is placed at different positions in accordance with movement of the moving object model, and
generate the training image, based on the plurality of two-dimensional images.

3. The computer according to claim 2, wherein the computer program further causes the processing circuitry to
specify, as the in-image position of the moving object area, a position of an area including the plurality of moving object models, in the training image.

4. The computer according to claim 1, wherein the computer program further causes the processing circuitry to
generate a two-dimensional image including the moving object model and the background model placed in the three-dimensional virtual space, and perform blurring processing on an image of the moving object model included in the two-dimensional image, to generate the training image.

5. The computer according to claim 4, wherein the computer program further causes the processing circuitry to
specify the in-image position of the moving object area including an area that has undergone the blurring processing.

6. The computer according to claim 4, wherein the computer program further causes the processing circuitry to
specify, as the in-image position, a position in the training image that corresponds to a position of the moving object area in the two-dimensional image that has not undergone the blurring processing yet.

7. The computer according to claim 1, wherein the computer program further causes the processing circuitry to
generate a plurality of two-dimensional images in which the moving object model is placed at different positions in accordance with movement of the moving object model,
generate a synthesized image based on the plurality of two-dimensional images, and
generate the training image by performing blurring processing on an image of the moving object model included in the synthesized image.

8. The computer according to claim 1, wherein
the moving object area is a rectangular area enclosing the image of the at least one moving object model.

9. A computer comprising:
a memory that stores a computer program; and
processing circuitry, where the computer program, when executed by the processing circuitry, causes the processing circuitry to
acquire a captured image including an afterimage according to movement of a moving object, and
detecting a moving object area including a moving object from the acquired captured image by using a detection model for detecting the moving object area from a captured image including an afterimage according to movement of a moving object, wherein
the detection model is generated by
generating a two-dimensional training image on which a moving object model and a background model placed in a three-dimensional virtual space are projected and which includes an afterimage according to movement of the moving object model,
specifying an in-image position, in the training image, of a moving object area including an image of at least one said moving object model, and
using a combination of the training image and the in-image position of the moving object area as training data.

10. An information processing method to be performed by a computer including a control section, the method comprising the steps of:
the control section acquiring a captured image including an afterimage according to movement of a moving object, and
using a detection model for detecting a moving object area including a moving object from a captured image including an afterimage according to movement of a moving object, the control section detecting the moving object area from the acquired captured image, wherein
the detection model is generated by
generating a two-dimensional training image on which a moving object model and a background model placed in a three-dimensional virtual space are projected and which includes an afterimage according to movement of the moving object model,
specifying an in-image position, in the training image, of a moving object area including an image of at least one said moving object model, and
using a combination of the training image and the in-image position of the moving object area as training data.
